(19) United States
(12) Patent Application Publication
(10) Pub. No.: US 2021/0263194 A1
(43) Pub. Date: Aug. 26, 2021

(54) Method for Manufacturing an Optical Component with a Coating

(71) Applicant: United States of America, as represented by the Secretary of the Army, Washington, DC (US)

(72) Inventor: Vincent P. Schnee, Alexandria, VA (US)

(21) Appl. No.: 17/115,868

(22) Filed: Dec. 9, 2020

Related U.S. Application Data
(60) Provisional application No. 62/981,709, filed on Feb. 26, 2020.

(51) Int. Cl. G02B 1/118; G02B 1/00; B29D 11/00

(52) U.S. Cl. CPC G02B 1/118; B29K 2063/00; B29D 11/00865; G02B 1/002

(57) ABSTRACT

A method for manufacturing an anti-reflective coating on a surface of an optical component includes the steps of placing a moth eye structure material in apertures of a stamp; placing the stamp on the surface of the optical component such that the moth eye material is in contact with the surface of the optical component; and removing the stamp after the moth eye structure material adheres to the surface of the optical component to create an anti-reflective coating on the surface of the optical component.

### CROSS-REFERENCE TO RELATED APPLICATIONS

This application claims priority to U.S. Provisional Patent Application No. 62/981,709, filed on Feb. 26, 2020, the disclosure of which is incorporated herein by reference in its entirety.

### GOVERNMENT INTEREST

The invention described herein may be manufactured, used, sold, imported, and/or licensed by or for the Government of the United States of America.

### FIELD OF THE INVENTION

The present subject matter relates generally to generating an optical component with a coating on the surface.

### BACKGROUND OF THE INVENTION

The surface of the eye of a moth is covered by bumps that are each roughly 200 nm high and whose centers are spaced approximately 300 nm apart. Since the bumps are smaller than the wavelength of visible light, visible light sees the surface as having a continuous refractive index gradient between the air and the medium, which decreases reflection by effectively removing the air-lens interface. Thus, the bumps serve as an anti-reflective coating on the eye of the moth,

Scientists would like to take advantage of this structure to add an anti-reflective coating to the surfaces of optical components, such as lenses. Such micro structures can be “printed” on the surface of an optical component by two photon lithography (also known as nano 3-D printing). However, this process is very time consuming, for example, taking on the order of 50 hours to create a moth eye structure over 1 cm² of optical component surface. Accordingly, the present inventors sought a way to create such a structure more efficiently.

In a similar manner, a method of efficiently manufacturing meta lenses is desired. Meta lenses are a thin substrate with a plurality of projections extending from one surface of the substrate. When electro optic radiation passes through the substrate, it is diffracted by the projections. Thus, with a particular set of projections, the radiation can be diffracted to converge at any desired focal length. However, manufacturing the projections can be very time consuming, as described above.

### SUMMARY OF THE INVENTION

The present invention broadly comprises a method for manufacturing an anti-reflective coating on a surface of an optical component including the steps of placing a moth eye structure material in apertures of a stamp; placing the stamp on the surface of the optical component such that the moth eye material is in contact with the surface of the optical component; and removing the stamp after the moth eye structure material adheres to the surface of the optical component to create an anti-reflective coating on the surface of the optical component.

In another embodiment, a method for manufacturing a diffractive coating on a surface of an optical component includes the steps of: placing a diffractive structure material in apertures of a stamp; placing the stamp on the surface of the optical component such that the diffractive material is in contact with the surface of the optical component; and removing the stamp after the diffractive structure material adheres to the surface of the optical component to create a diffractive coating on the surface of the optical component.

### BRIEF DESCRIPTION OF THE DRAWINGS

A full and enabling disclosure of the present subject matter, including the best mode thereof, directed to one of ordinary skill in the art, is set forth in the specification, which makes reference to the appended figures, in which:

FIG. 1 illustrates a flow chart of a first embodiment of the present invention;

FIG. 2 shows a flow chart of a method embodiment for making a stamp;

FIG. 3 illustrates making a stamp in accordance with the method shown in FIG. 2;

FIG. 4 illustrates making an anti-reflective coating in accordance with the method shown in FIG. 1;

FIG. 5 shows an alternative embodiment for making an anti-reflective coating in accordance with the method shown in FIG. 1;

FIG. 6a illustrates a side view of an optical component with a diffractive coating in accordance with an alternative embodiment of the present invention; and

FIG. 6b illustrates a perspective view of an optical component with a diffractive coating in accordance with an alternative embodiment of the present invention.

### DETAILED DESCRIPTION

Reference is presently made in detail to exemplary embodiments of the present subject matter, one or more examples of which are illustrated in or represented by the drawings. Each example is provided by way of explanation of the present subject matter, not limitation of the present subject matter. In fact, it will be apparent to those skilled in the art that various modifications and variations can be made in the present subject matter without departing from the scope or spirit of the present subject matter. For instance, features illustrated or described as part of one embodiment can be used with another embodiment to yield a still further embodiment. Thus, it is intended that the present subject matter covers such modifications and variations as come within the scope of the disclosure and equivalents thereof

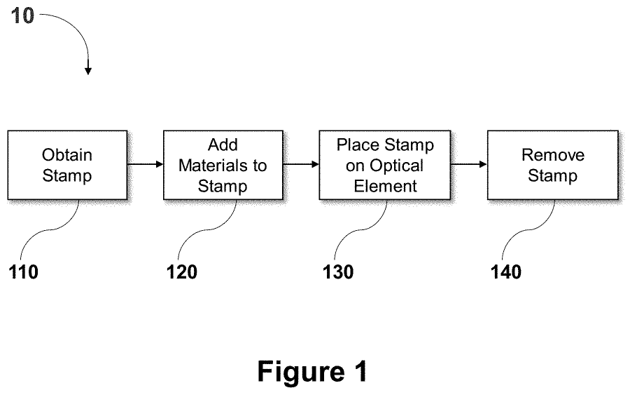

FIG. 1 illustrates a process 10 for generating an optical component with an anti-reflective coating on the surface according to a first embodiment of the present invention. Process 10 includes the steps of obtaining a stamp (step 110), adding material to apertures in the stamp (step 120), placing the stamp on a surface of an optical element (step 130), and removing the stamp (step 140).

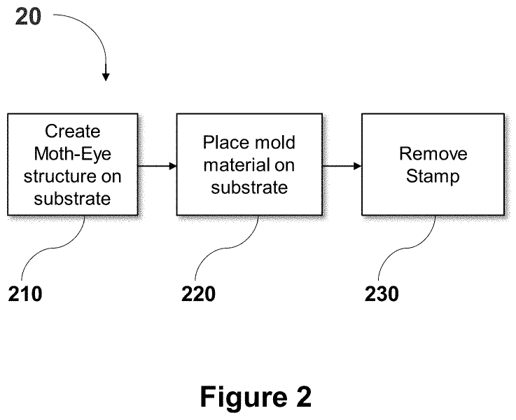

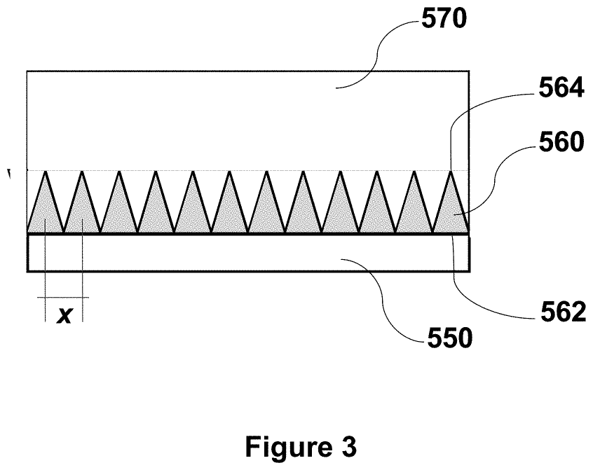

Step 110 may include a method of making a stamp, as described by the flow chart in FIG. 2, and as illustrated in FIG. 3. Method 20 includes creating a moth eye structure on a substrate (step 210), placing a mold material on the substrate (step 220), and removing the stamp (step 230). In step 210, a moth eye structure including a plurality of projections 560 is formed on substrate 550. This may be done by two photon lithography, or by any other process known in the art.

In one embodiment that creates an anti-reflective coating for ultra violet or visible light wavelengths, the projections 560 are on the order of 5 nm wide at each tip 564, and 10's of nm tall. In an embodiment that creates an anti-reflective coating for wavelengths of approximately 3-12 μm, projections 560 are 6 μm tall and 10's of nm wide at tip 564. Further, in one embodiment, each projection base 562 is in contact with the base of another projection base 562. However, projection bases may be further apart in accordance with the following equation:

D≤X≤λ/3,

where X is the distance between adjacent centers of bases 562, D is the diameter of bases 562, and λ is the shortest wavelength of electromagnetic radiation of interest.

A mold material is then placed on the substrate in step 220. In one embodiment, the mold material is polydimethylsiloxane (PDMS). Once the mold material has solidified, stamp 570 is removed in step 230.

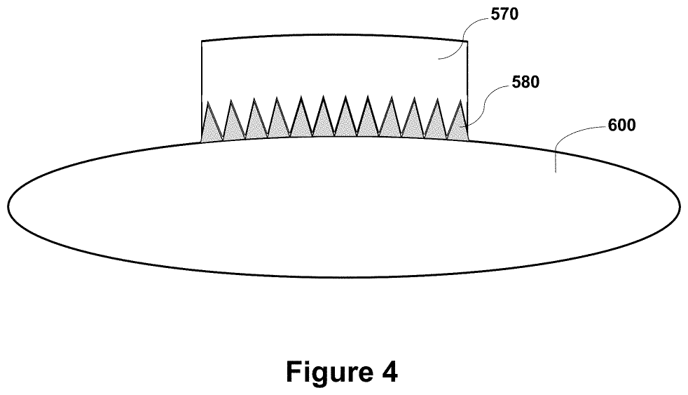

FIG. 4 shows stamp 570 with moth eye structure material 580 in the apertures of the stamp 570. In one embodiment, moth eye structure material 580 includes epoxy and germanium nanoparticles. Stamp 570 is placed on a surface 600 of an optical element. Once moth eye structure material 580 has adhered to surface 600, stamp 570 is removed.

In another embodiment, moth eye structure material 580 includes epoxy and particles of the same material as the optical element. This allows perfect matching of indices of refraction between the optical element and the anti-reflective coating. Such a perfect match is not easily achieved with conventional layered dielectric anti-reflective coatings.

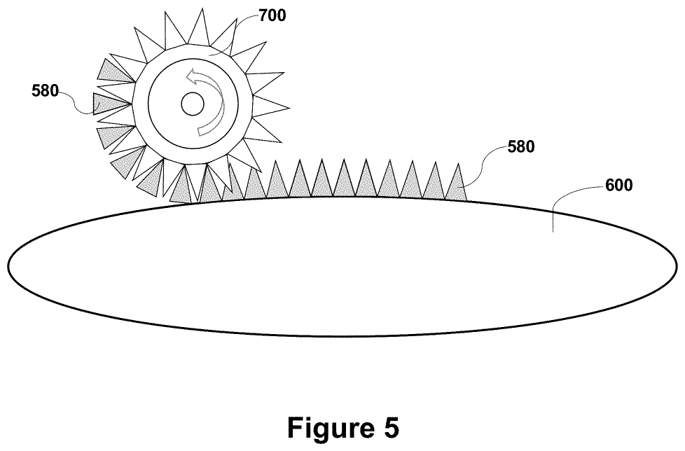

FIG. 5 illustrates an alternative way to use stamp 570. In this case, stamp 570 is wrapped around the surface of cylinder 700. Moth eye structure material 580 is added to the apertures, and then cylinder 700 is rolled across the surface 600 of an optical element. In this manner, material 580 is transferred to surface 600, creating an anti-reflective coating on surface 600.

In another embodiment using cylinder 700, a layer of moth eye structure material 580 is placed on the surface 600, and then cylinder 700 is rolled over surface 600 to create the anti-reflective coating.

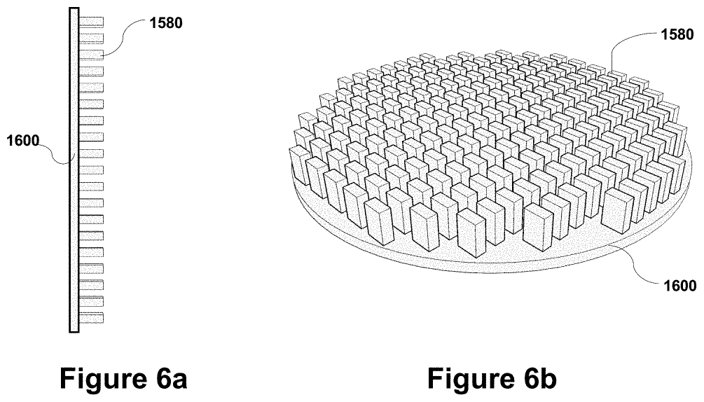

FIG. 6a illustrates a side view of an exemplary meta lens including a substrate 1600 and a plurality of projections 1580 extending from a surface of substrate 1600. FIG. 6b illustrates a perspective view of such exemplary meta lens. Projections 1580 can be formed on the substrate 1600 as described above with a flat or roller stamp. In one embodiment, projections 1580 may have a width and length of approximately 100 nm and a height of approximately 500 nm, and may be spaced 400 nm apart (exact dimensions are optimized based on the wavelength of light to be diffracted). Manufacturing an optical component with an anti-reflective coating or a meta lens are both within the scope of the invention as claimed.

The present written description uses examples to disclose the present subject matter, including the best mode, and also to enable any person skilled in the art to practice the present subject matter, including making and using any devices or systems and performing any incorporated and/or associated methods. While the present subject matter has been described in detail with respect to specific embodiments thereof, it will be appreciated that those skilled in the art, upon attaining an understanding of the foregoing may readily produce alterations to, variations of, and equivalents to such embodiments. Accordingly, the scope of the present disclosure is by way of example rather than by way of limitation, and the subject disclosure does not preclude inclusion of such modifications, variations and/or additions to the present subject matter as would be readily apparent to one of ordinary skill in the art.

What is claimed is:

1. A meta lens based on an optical element, the meta lens comprising:
an optical element comprising a substrate having an optical surface; and
a plurality of uniformly spaced projections of a moth eye structure material adhered to said substrate and projecting from said optical surface, wherein said moth eye structure material forms an anti-reflective coating of moth eye structure on said optical element.

2. The meta lens based on an optical element according to claim 1, wherein, said projections have a width and length of approximately 100 nm and a height of approximately 500 nm, and are spaced 400 nm apart to form an anti-reflective coating of moth eye structure on said optical element.

3. The meta lens based on an optical element according to claim 1, wherein, said projections are about 5 nm wide at each tip, and at least 10 nm tall to form an anti-reflective coating of moth eye structure on said optical element for ultra violet or visible light wavelengths.

4. The meta lens based on an optical element according to claim 1, wherein, said projections are about 6 μm tall and at least 10 nm wide at tip to form an anti-reflective coating of moth eye structure on said optical element for wavelengths of approximately 3-12 μm.

5. The meta lens based on an optical element according to claim 1, wherein each projection has a base in contact with the base of another projection.

6. The meta lens based on an optical element according to claim 1, wherein each projection has a base uniformly spaced on said substrate in accordance with:
D≤X≤λ/3,
wherein, X is the distance between adjacent centers of the bases, D is the diameter of the bases, and λ is a shortest wavelength of electromagnetic radiation of interest.

7. The meta lens based on an optical element according to claim 1, wherein said moth eye structure material is comprised of epoxy and germanium nanoparticles.

8. The meta lens based on an optical element according to claim 1, wherein said moth eye structure material is comprised of epoxy and particles of the substrate material of the optical element.

9. A method for manufacturing the meta lens based on an optical element according to claim 1, the method comprising the steps of:
adding a moth eye structure material in apertures of a stamp;
placing the stamp on the optical surface of the optical element such that the added moth eye structure material is in contact with the optical surface of the optical element; and
removing the stamp after the added moth eye structure material adheres to the optical surface of the optical component to create an anti-reflective coating of moth eye structure on the optical surface of the optical element.

10. The method for manufacturing the meta lens based on an optical element according to claim 9, wherein the moth eye structure material includes an epoxy and germanium nanoparticles.

11. The method for manufacturing the meta lens based on an optical element according to claim 9, wherein the optical element is a lens.

12. The method for manufacturing the meta lens based on an optical element according to claim 9, wherein the stamp is wrapped around a cylindrical surface of a rolling cylinder.

13. The method for manufacturing the meta lens based on an optical element according to claim 12, wherein the step of placing the stamp on the optical surface includes rolling the stamp around the rolling cylinder over the optical surface of the optical element.

14. The method for manufacturing the meta lens based on an optical element according to claim 9, further comprising:
making the stamp by:
creating a moth eye structure on a surface of a mold substrate, the moth eye structure including a plurality of projections extending from the surface of the mold substrate;
forming a stamp of moth eye structure by placing a mold material on the moth eye structure of the mold substrate; and
removing the stamp formed of the mold material from the moth eye structure of the mold substrate.

15. The method for manufacturing the meta lens based on an optical element according to claim 14, wherein a base of each of the plurality of projections is in contact with a base of an adjacent projection.

16. The method for manufacturing the meta lens based on an optical element according to claim 14, wherein the mold material is polydimethylsiloxane.

17. A method for manufacturing a diffractive coating on a surface of an optical element, the method comprising the steps of:
placing a layer of diffractive structure material on an optical surface of the optical element;
rolling a stamp having apertures of a moth eye structure on a cylinder over the layer of diffractive structure material such that a moth eye structure is impressed onto the layer of diffractive structure material on the optical surface of the optical element; and
removing the stamp after the stamp is rolled over the layer of diffractive structure material, wherein the moth eye structure impressed onto the layer of diffractive structure material creates a diffractive coating on the optical surface of the optical element.

18. The method for manufacturing a diffractive coating on a surface of an optical element according to claim 17, wherein a stamp having apertures forming a moth eye structure is wrapped around a cylindrical surface of a rolling cylinder to make the stamp having apertures of a moth eye structure on a cylinder.
